(19) United States
(12) Patent Application Publication
(10) Pub. No.: US 2006/0139030 A1
(43) Pub. Date: Jun. 29, 2006

(54) System and method for diagnosing manufacturing defects in a hearing instrument

(76) Inventors: Bradley J. Hubbard, Hamilton (CA); Stephen W. Armstrong, Burlington (CA)

Correspondence Address: Joseph M. Sauer, Esq.;Jones Day, North Point, 901 Lakeside Avenue, Cleveland, OH, 44114, US

(21) Appl. No.: 11/302,794

(22) Filed: Dec. 14, 2005

Related U.S. Application Data
(60) Provisional application No. 60/636,928, filed on Dec. 17, 2004.

(51) Int. Cl. G01V 3/00

(52) U.S. Cl. 324/322

(57) ABSTRACT

In accordance with the teachings described herein, systems and methods are provided for diagnosing manufacturing defects in a digital hearing instrument. A system may include a hearing instrument component that is electrically connected to a hearing instrument integrated circuit. A diagnostic program may be stored in a memory location on the hearing instrument integrated circuit, the diagnostic program when executed by the hearing instrument integrated circuit being operable to test an operation of the hearing instrument component and indicate a failed operation of the hearing instrument component using a test indicator.

This application claims priority from provisional case 60/636928 filed Dec. 17, 2004, which is hereby incorporated by reference.

### FIELD

The technology described in this patent document relates generally to hearing instruments. More specifically, this document describes a system and method for diagnosing manufacturing defects in a hearing instrument.

### BACKGROUND

During the assembly of a digital hearing instrument, one or more hearing instrument integrated circuits (IC) are electrically connected to the receiver, microphone, and other components that make up a digital hearing instrument. Often, bad solder joints, missed connections or other manufacturing defects cause significant delay in the manufacturing process. For instance, if a newly assembled hearing instrument does not work, then the assembler or other personnel may have to manually examine each of the connections and attempt to diagnose the defect.

### SUMMARY

In accordance with the teachings described herein, systems and methods are provided for diagnosing manufacturing defects in a digital hearing instrument. A system may include a hearing instrument component that is electrically connected to a hearing instrument integrated circuit. A diagnostic program may be stored in a memory location on the hearing instrument integrated circuit, the diagnostic program when executed by the hearing instrument integrated circuit being operable to test an operation of the hearing instrument component and indicate a failed operation of the hearing instrument component using a test indicator.

### BRIEF DESCRIPTION OF THE DRAWINGS

FIG. 1 is a block diagram of an example hearing instrument diagnostic system.

FIG. 2 is a block diagram of an example hearing instrument diagnostic system for testing microphone circuitry.

FIG. 3 is a block diagram of an example hearing instrument diagnostic system for testing microphone circuitry and receiver circuitry.

FIG. 4 is a block diagram of another example hearing instrument diagnostic system for testing microphone circuitry and receiver circuitry.

FIG. 5 is a block diagram of an example hearing instrument diagnostic system for testing microphone circuitry, receiver circuitry and one or more input devices.

FIG. 6 is a flow diagram of an example process for diagnosing manufacturing defects in a hearing instrument.

FIG. 7 is a flow diagram of an example method for diagnosing manufacturing defects in a hearing instrument.

FIG. 8 is a flow diagram of a second example method for diagnosing manufacturing defects in a hearing instrument.

FIG. 9 is a flow diagram of a third example method for diagnosing manufacturing defects in a hearing instrument.

FIG. 10 is a flow diagram of a fourth example method for diagnosing manufacturing defects in a hearing instrument.

FIG. 11 is a flow diagram of a fifth example method for diagnosing manufacturing defects in a hearing instrument.

FIGS. 12A and 12B are a block diagram of an example hearing instrument.

### DETAILED DESCRIPTION

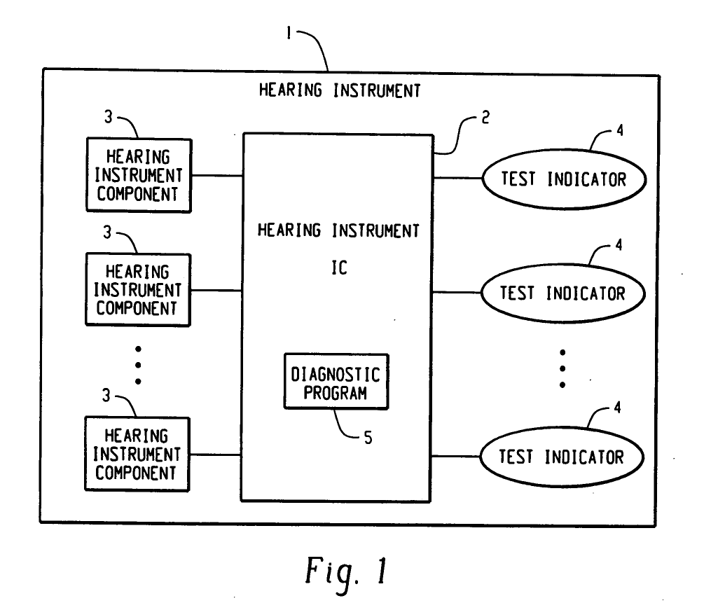

FIG. 1 is a block diagram of an example hearing instrument diagnostic system in a digital hearing instrument 1. The digital hearing instrument 1 includes a hearing instrument integrated circuit 2 that is electrically coupled to a plurality of hearing instrument components 3 during assembly of the digital hearing instrument 1. The hearing instrument components 3 may, for example, include a microphone circuitry, a receiver (i.e. speaker) circuitry, an input device and/or other hearing instrument devices or circuitries. Also included is a diagnostic program 5, which may be firmware stored in a memory location on the hearing instrument integrated circuit 2, and one or more test indicators 4.

The diagnostic program 5 when executed by the hearing instrument integrated circuit is operable to test the operation of one or more of the hearing instrument components and indicate a failed operation using the test indicator(s) 4. The test indicators 4 may, for example, include a tone generator, a light source and/or other devices for indicating the results of the diagnostic tests performed by the diagnostic program to a hearing instrument assembler or to some other person or machine. If the test indicator(s) 4 indicates a failed operation for a particular hearing instrument component 3, then the electrical connection between the hearing instrument component and the hearing instrument IC 2 may be missing or faulty or the hearing instrument component may be defective.

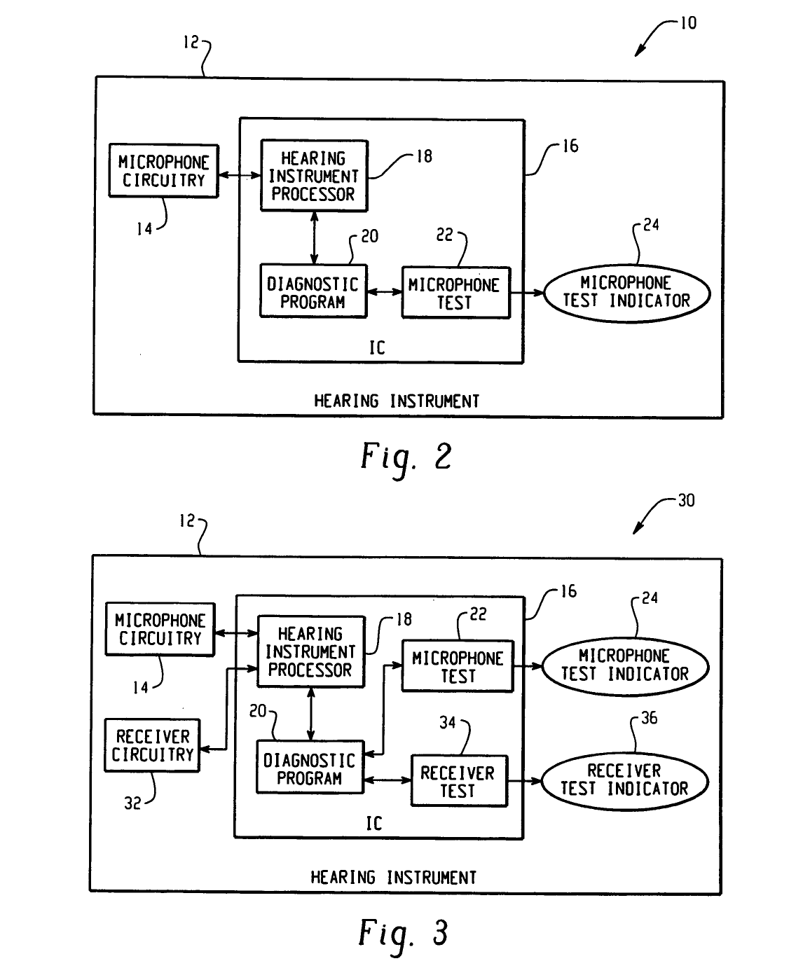

FIG. 2 is a block diagram of an example hearing instrument diagnostic system 10 for testing microphone circuitry 14. The system includes a hearing instrument assembly 12 having microphone circuitry 14 that has been electrically connected to a hearing instrument IC 16. The hearing instrument IC 16 includes a hearing instrument processor 18 that executes a diagnostic program 20, which may be stored as firmware on the IC 16. The diagnostic program 20 is operable to perform a microphone test 22 to verify that the microphone circuitry 14 is properly connected to the IC 16 and is functional. Also included in the system 10 is a microphone test indicator 24, such as a tone generator, a light source, or some other device for indicating the result of the microphone test 22 to a hearing instrument assembler or to some other person or machine.

The diagnostic program 20 may cause the microphone test indicator 24 to generate a first output if the microphone test 22 is passed and a second output if the microphone test is failed. For example, if the microphone test indicator 24 is a tone generator, then a first tone or tone pattern (e.g., a beeping tone) may be generated upon a failed microphone test 22 and a second tone or tone pattern (e.g., a constant tone) may be generated upon a successful microphone test 22.

The microphone test 22 may be performed by monitoring the energy level of the audio output signal generated by the microphone circuitry. If the energy level of the microphone output remains above a pre-determined threshold level, then the diagnostic program 20 may determine that the microphone circuitry 14 is properly connected and functional and cause the microphone test indicator 24 to generate a first output indicating a successful microphone test 22. If the energy level of the microphone output falls below the pre-determined threshold level, however, then the diagnostic program 20 may cause the microphone test generator 24 to generate a second output indicating a failed microphone test 22.

FIG. 3 is a block diagram of an example hearing instrument diagnostic system 30 for testing microphone circuitry 14 and receiver circuitry 32. This example 30 is similar to the system 10 of FIG. 2, with the addition of a receiver test 34 and a receiver test indicator 36 for verifying that receiver circuitry 32 is connected and functioning properly. The receiver circuitry 32 may include a speaker and other circuitry for generating an audio output signal, and is electrically connected to the hearing instrument IC 16 within the hearing instrument assembly 12. In this example 30, the hearing instrument diagnostic program 20 is operable to perform both the microphone test 22 described above and the receiver test 34.

The receiver test indicator 36 may, for example, be a light source or some other device for indicating the result of the speaker test 34 to a hearing instrument assembler or to some other person or machine. The diagnostic program 20 may cause the receiver test indicator 36 to generate a first output if the receiver test 34 is passed and a second output if the receiver test is failed. For example, if the receiver test indicator 36 is a light source, then the light source may light upon a failed receiver test 34 and not light when the receiver test 34 is successful.

The receiver test 34 may be performed by instructing the receiver circuitry to generate a pre-determined audio output signal and monitoring for a concurrent drop in the hearing instrument's battery voltage. The pre-determined audio output signal should cause the battery voltage of the hearing instrument to drop by a known amount. If the battery voltage does riot drop as predicted in response to an instruction to the receiver circuitry 32 to generate the pre-determined audio output signal, then it may be determined by the diagnostic program 20 that the receiver test 34 has failed because the receiver circuitry 32 is not properly connected or is otherwise malfunctioning.

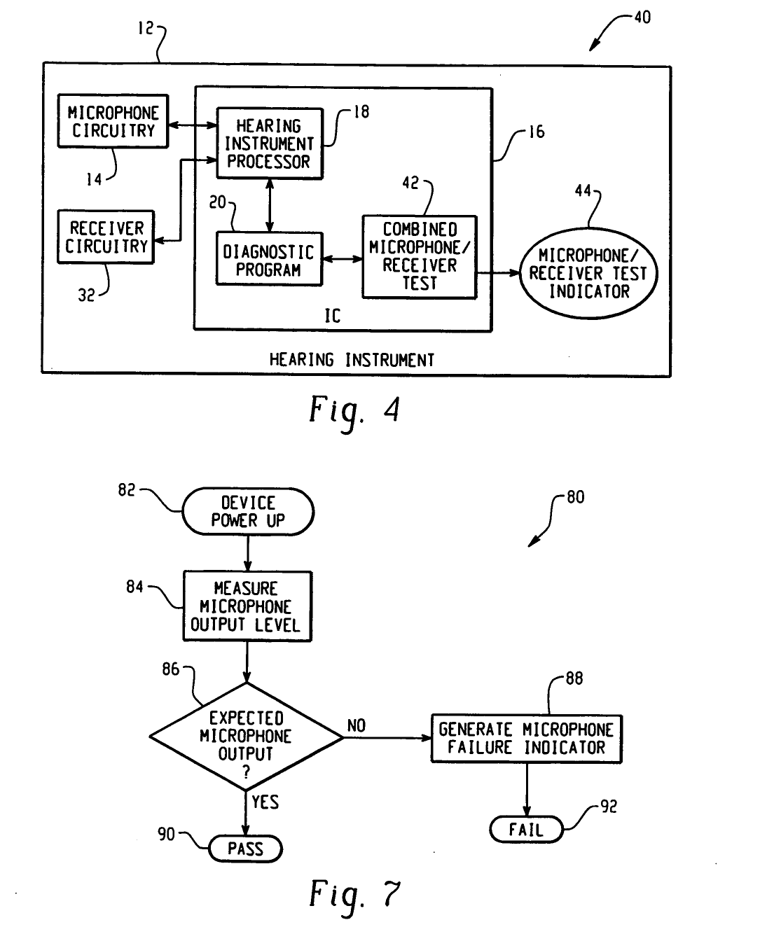

FIG. 4 is a block diagram of another example hearing instrument diagnostic system 40 for testing microphone circuitry 14 and receiver circuitry 32. This example 30 is similar to the system of FIG. 3, except that the diagnostic program 20 performs a combined microphone and receiver test 42. In addition, the microphone and receiver test indicators 24, 26 of FIG. 3 are replaced in this example 40 by a single microphone and receiver test indicator 44.

The microphone and receiver test indicator 44 is this example 40 ma be a tone generator or other device for generating an audible tone with the receiver circuitry 32. The combined microphone and receiver test 42 may include a test to determine if the microphone circuitry 14 is properly connected and functioning, as described above with reference to FIG. 2. If the microphone test is passed, then the microphone and receiver test indicator 44 may generate a first audible output (e.g., a first tone or tone pattern) using the receiver circuitry 32. Similarly, if the microphone test fails, then the microphone and receiver test indicator 44 may generate a second audible output (e.g., a second tone or tone pattern) using the receiver circuitry 32. The receiver portion of the combined microphone and receiver test 42 is performed by the hearing instrument assembler or other person or machine listening for the audio output generated by the receiver circuitry 32 as a result of the microphone test. If no audio output is heard, then the receiver circuitry 32 may be improperly connected or otherwise malfunctioning, and the receiver test 42 is failed. If an audio output is heard, then the receiver circuitry 32 is functioning and the receiver portion of the test 42 is passed.

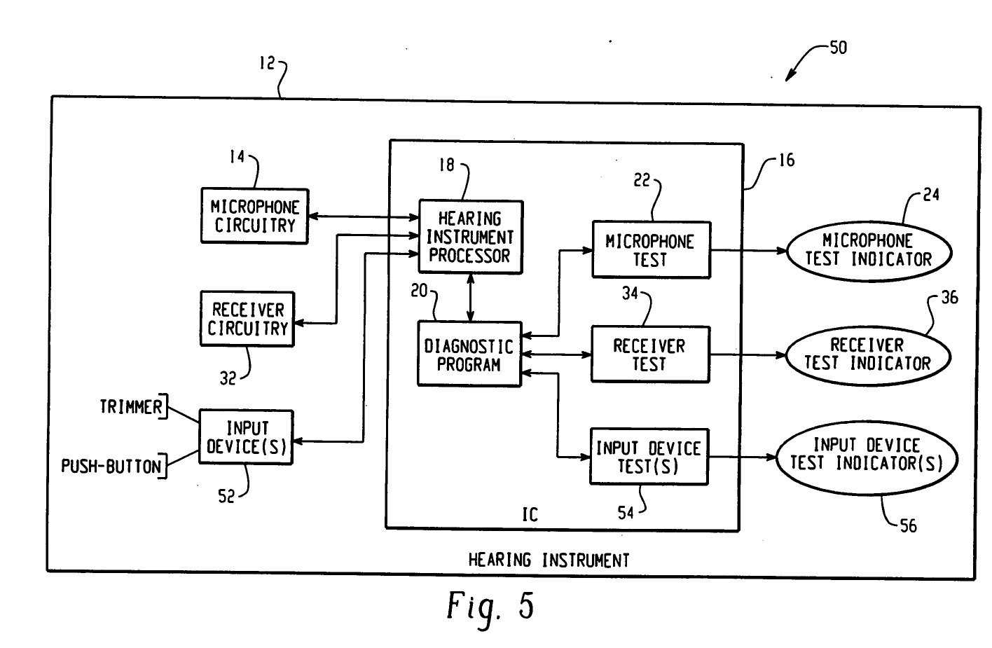

FIG. 5 is a block diagram of a fourth example hearing instrument diagnostic system 50 for testing microphone circuitry 14, receiver circuitry 32 and one ore more input devices 52. This example 50 is similar to the system 30 of FIG. 3, with the addition of one or more input device tests 54 and one or more input device test indicators 56. The input devices 52 may, for example, include one or more trimmers (e.g., potentiometers), one or more push-button switches and/or other similar input devices that are electrically connected to the hearing instrument IC 16 within the hearing instrument assembly 12.

In addition to the microphone and receiver tests 22, 34 described above, the diagnostic program 20 in this example 50 is operable to determine if the one or more input devices 52 are electrically connected to the hearing instrument IC 16 and are functioning properly. The input device test indicator(s) 56 may, for example, include one or more tone generators, light sources and/or other device(s) for indicating the result of the input device test(s) 54 to a hearing instrument assembler or to some other person or machine.

The input device test(s) 54 may be performed by generating an audible tone that changes in response to input from the one or more input devices 52. If the audible tone responds as expected to the input from the input device(s) 52; then the test 54 is passed. For example, a trimmer may be tested by generating an audible test tone that changes depending on the direction of the input from the trimmer. For example, the audible test tone may increase in frequency if the trimmer is moved in a first direction and decrease in frequency if the trimmer is moved in a second direction. If the expected increase/decrease in the frequency of the test tone does not result from a trimmer adjustment, then the input device test 22 is failed. In another example, a push-button switch may be tested by generating an audible tone that stops/starts or a light that turns on/off as the push-button switch is pressed and released. If the input device indicator 56 (e.g., audible tone or light) does not respond as expected when the push-button switch is pressed and released, then the input device test 54 fails.

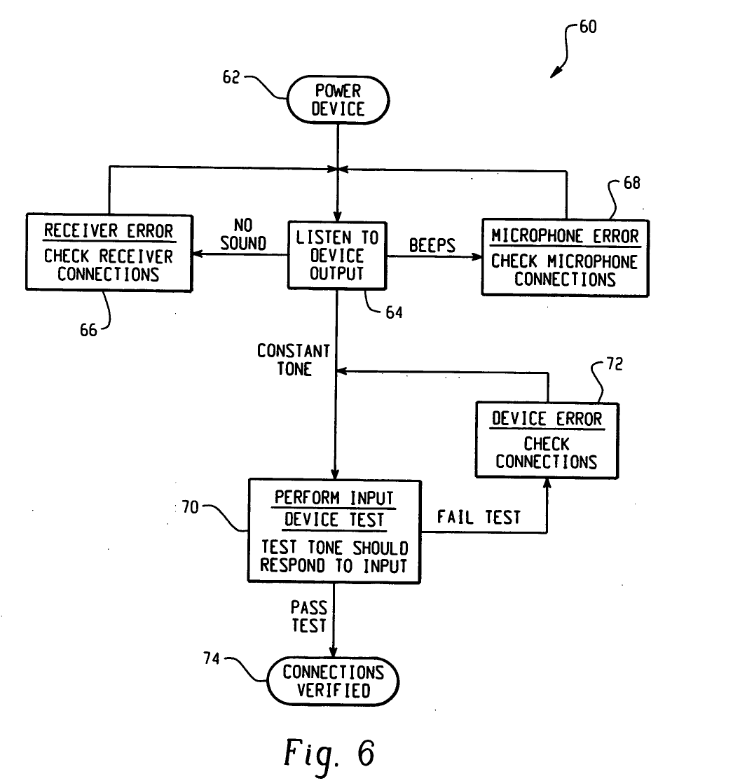

FIG. 6 is a flow diagram of an example process 60 for diagnosing manufacturing defects in a hearing instrument. The illustrated process 60 may, for example, be performed by a hearing instrument assembler or other person or machine (“assembler”) to ensure that a hearing instrument has been properly assembled and is functioning. The process 60 begins with step 62 by powering on the hearing instrument assembly. Then, at step 64 the assembler listens for an audible output from the hearing instrument assembly. If no audible output is heard at step 64, then the receiver circuitry may be improperly connected or otherwise malfunctioning, and thus the receiver circuitry is checked for assembly defects (e.g., missing or faulty electrical connections) at step 66.

A beeping audible output at step 64 alerts the assembler of a microphone error. The microphone error may, for example, be detected by a diagnostic program executing on the hearing instrument, as described above with reference to FIG. 2. Thus, if a beeping audible output is heard at step 64, then the assembler checks the microphone circuitry for assembly defects (e.g, missing or faulty electrical connections) at step 68.

A constant audible output at step 64 alerts the assembler that a successful microphone test has been completed, and the process proceeds to step 70. At step 70, a test is performed on one or more input devices, such as trimmer(s), push-button switch(s) and/or other similar input device(s). The input device test may, for example, be performed by adjusting the input device(s) and listening for a resultant change in the constant audible output, as described above with reference to FIG. 5. If the test tone responds as expected to the input device adjustment (e.g., frequency increases/decreases depending on the direction of a trimmer adjustment), then the input device test is passed and the process ends at step 74. If the test tone does not respond as expected to the input device test, however, then the input device(s) may be improperly connected or otherwise malfunctioning, and the input device connections are checked at step 72.

FIG. 7 is a flow diagram of an example method 80 for diagnosing manufacturing defects in a hearing instrument. The method 80 may, for example, be performed by a diagnostic program executing on the hearing instrument, as described above with reference to FIGS. 1-4. The method 80 begins at step 82 when the hearing instrument assembly is powered on. Then, at step 84, the energy level of the audio output signal generated by the microphone circuitry is measured. If the measured microphone output level is at or above a pre-determined threshold energy level (step 86), then the test is passed and the method ends at step 90. However, if the measured microphone output level is below the pre-determined threshold energy level (step 86), then a microphone failure indicator (e.g., a beeping tone) is generated at step 88, and the method ends with a failed test at step 92.

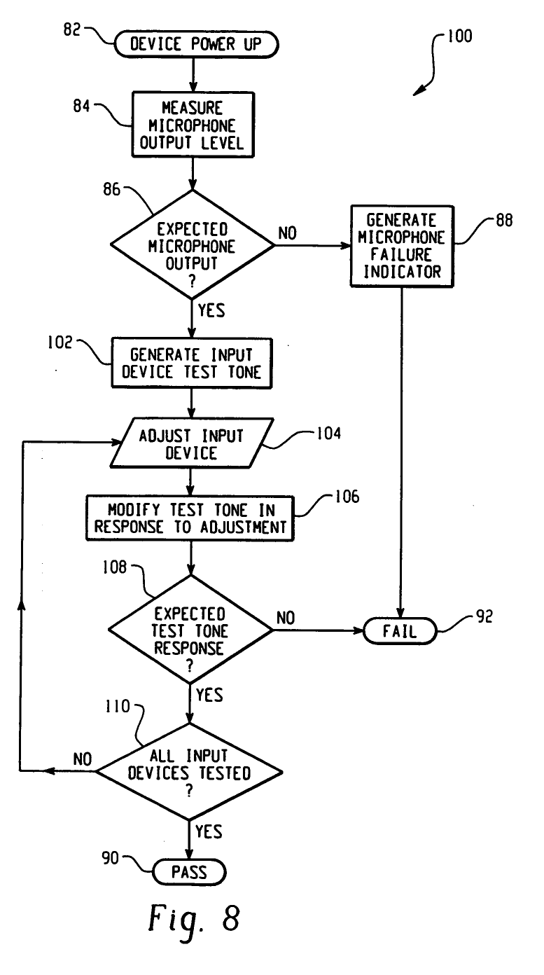

FIG. 8 is a flow diagram of a second example method 100 for diagnosing manufacturing defects in a hearing instrument. The method 100 may, for example, be performed by a diagnostic program executing on the hearing instrument, as described above with reference to FIGS. 1-4. The method 80 begins at step 82 when the hearing instrument assembly is powered on. Then, at step 84, the energy level of the audio output signal generated by the microphone circuitry is measured. If the measured microphone output level is at or above a pre-determined threshold energy level (step 86), then the microphone test is passed and the method proceeds to step 102. However, if the measured microphone output level is below the pre-determined threshold energy level (step 86), then a microphone failure indicator (e.g., a beeping tone) is generated at step 88, and the method ends with a failed test at step 92.

At step 102, an input device test tone is generated, such as a constant tone. The input device under test is then adjusted by the assembler at step 104, and the input device test tone is modified in response to the adjustment at step 106. For example, the input device test tone may increase in frequency if a trimmer is adjusted in a first direction and decrease in frequency if a trimmer is adjusted in a second direction, as described above with reference to FIG. 5. If the input device test tone responds as expected to the input device adjustment (step 108), then the method 100 proceeds to step 110. Else, if the input device test tone does not respond as expected to the input device adjustment (step 108), then the method ends with a failed test at step 92.

At step 110, the method 100 determines if all of the input devices have been tested. If not, then the method 100 returns to step 104. Otherwise, if all of the input devices have been tested, then the test is passed and the method 100 ends at step 90.

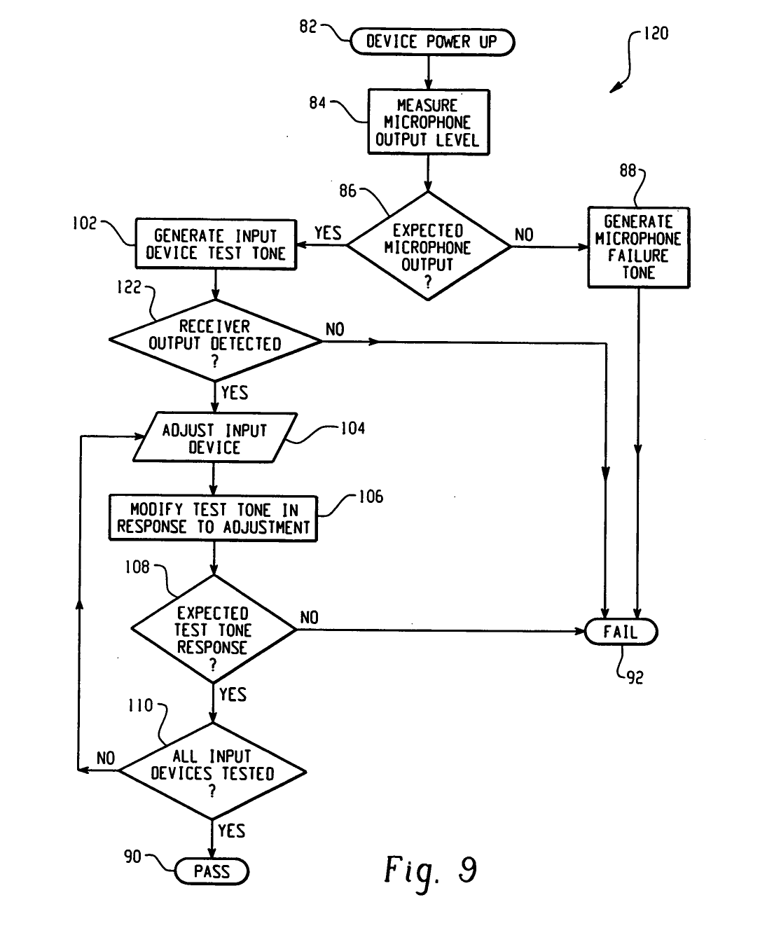

FIG. 9 is a flow diagram of a third example method 120 for diagnosing manufacturing defects in a hearing instrument. This example 120 is similar to the method 100 of FIG. 8, with the addition of a test for the receiver circuitry at step 122. After the input device test tone is generated at step 102, the method 120 uses the test tone to test the functionality of the receiver circuitry at step 122. The method 120 may, for example, test the receiver circuitry by monitoring for a drop in battery voltage concurrent with the expected output of the input device test tone. If the input device test tone is detected in the receiver output (e.g., by a drop in battery voltage), then the method 120 proceeds to step 104, and continues as described above with reference to FIG. 8. However, if no receiver output is detected at step 122 (e.g., the battery voltage is unchanged), then the method 120 ends with a failed test at step 92.

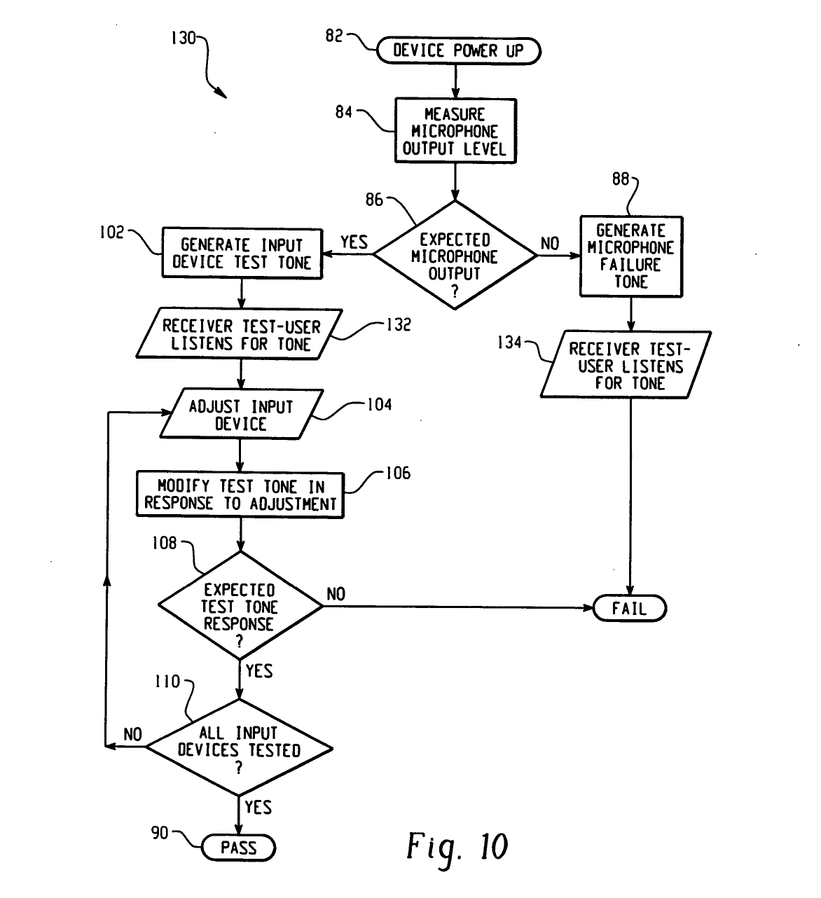

FIG. 10 is a flow diagram of a fourth example method 130 for diagnosing manufacturing defects in a hearing instrument. This example 120 is similar to the method 100 of FIG. 8, with the addition of a receiver circuitry test at step 132 or step 134. The receiver circuitry test is performed by the assembler listening for the input device test tone (step 132) or the microphone failure tone (step 134). If the expected tone is not heard by the assembler, then the receiver circuitry may be improperly connected or otherwise malfunctioning.

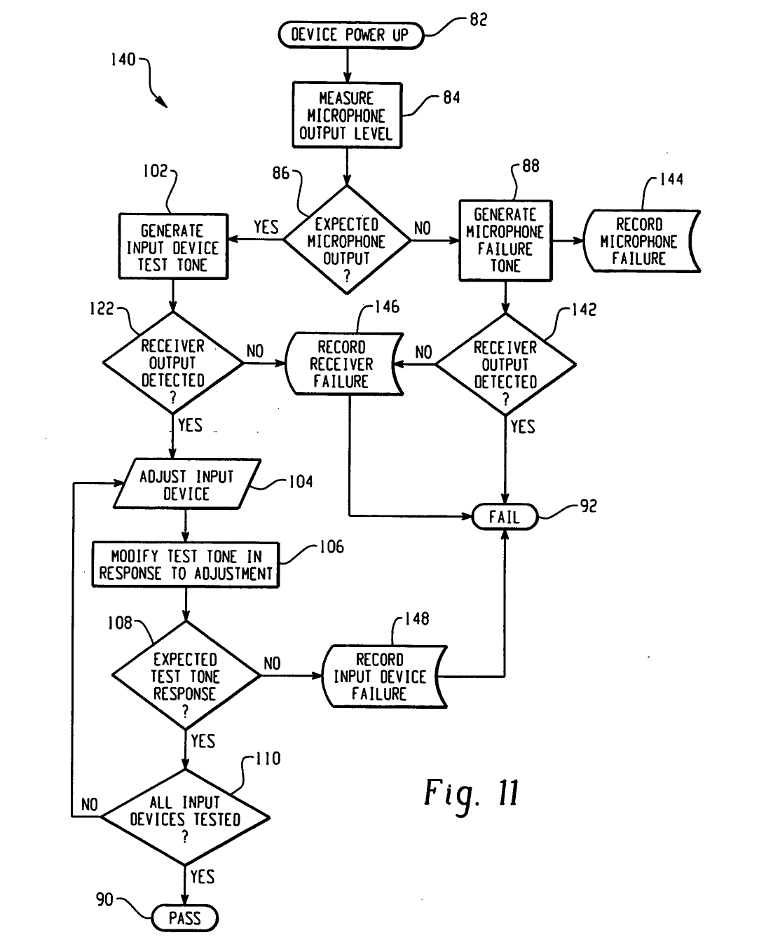

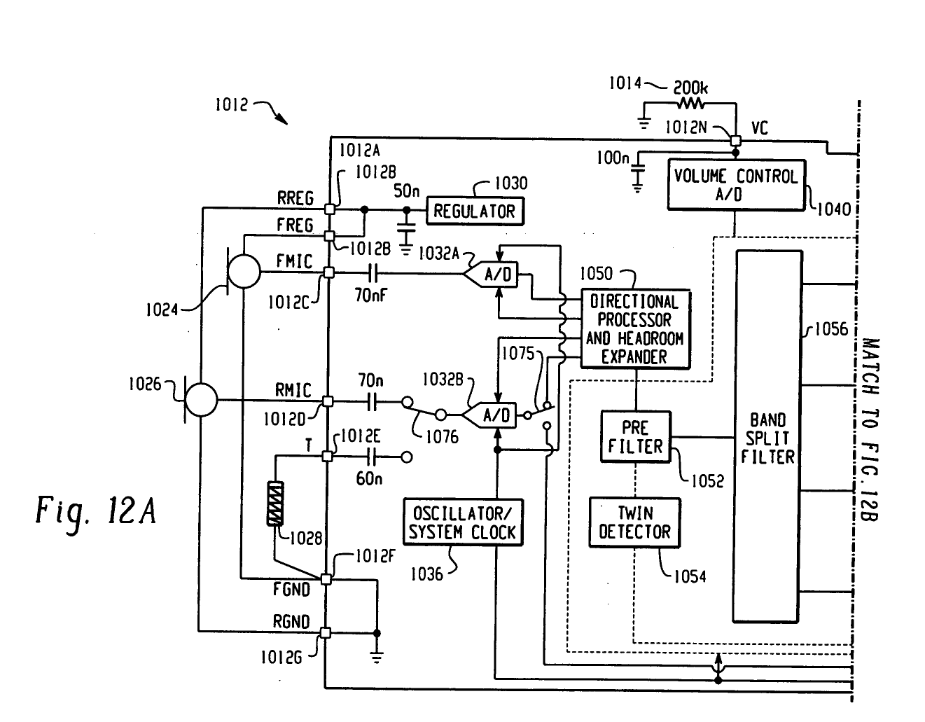

FIG. 11 is a flow diagram of a fifth example method 140 for diagnosing manufacturing defects in a hearing instrument. The method 140 may, for example, be performed by a diagnostic program executing on the hearing instrument, as described above with reference to FIGS. 1-4. The method 140 begins at step 82 when the hearing instrument assembly is powered on. Then, at step 84, the energy level of the audio output signal generated by the microphone circuitry is measured. If the measured microphone output level is at or above a pre-determined threshold energy level (step 86), then the microphone test is passed and the method proceeds to step 102 to generate an input device test tone. However, if the measured microphone output level is below the pre-determined threshold energy level (step 86), then a microphone failure indicator (e.g., a beeping tone) is generated at step 88, a microphone failure is recorded at step 144, and the method proceeds to step 142 to test the receiver output. The microphone failure may, for example, be recorded on a memory device on the hearing instrument or may be recorded on an external memory device via a connection to a hearing instrument input/output port.

A receiver test is performed at step 122 or step 142 of the method 140. If the microphone test was passed (step 86), then the receiver test is performed using the input device test tone generated at step 102. If the microphone test was failed (step 86), then the receiver test is performed using the microphone failure tone generated at step 102. The method 140 may, for example, test the receiver circuitry by monitoring for a drop in battery voltage concurrent with the expected output of the input device test tone or microphone failure tone. If the expected test tone is detected in the receiver output (e.g., by a drop in battery voltage), then the method 140 proceeds to step 104 to test the input device or to step 92 to end with a failed microphone test. However, if no receiver output is detected at step 122 or step 142 (e.g., the battery voltage is unchanged), then a receiver failure is recorded at step 146 and the method 120 ends with a failed test at step 92.

At step 104, the input device under test is adjusted by the assembler, and the input device test tone is modified in response to the adjustment at step 106. For example, the input device test tone may increase in frequency if a trimmer is adjusted in a first direction and decrease in frequency if a trimmer is adjusted in a second direction, as described above with reference to FIG. 5. If the input device test tone responds as expected to the input device adjustment (step 108), then the method 140 proceeds to step 110. Else, if the input device test tone does not respond as expected to the input device adjustment (step 108), then a input device test failure is recorded at step 148 and the method ends with a failed test at step 92.

At step 110, the method 140 determines if all of the input devices have been tested. If not, then the method 100 returns to step 104. Otherwise, if all of the input devices have been tested, then the test is passed and the method 140 ends at step 90.

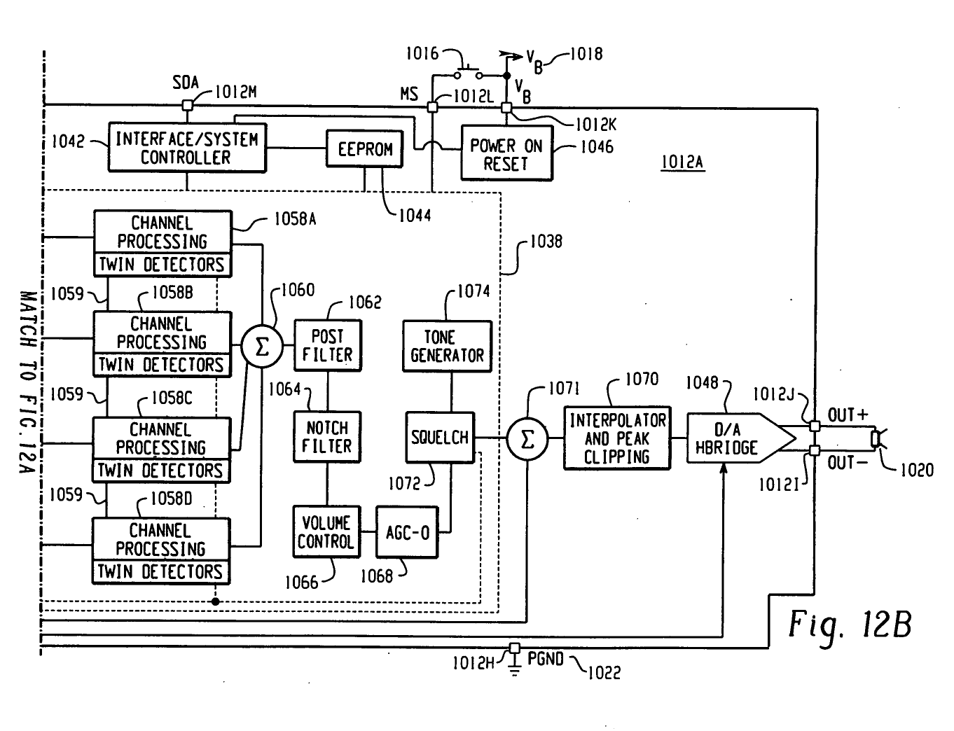

FIGS. 12A and 12B are a block diagram of an example digital hearing aid system 1012 that may incorporate the system and method for diagnosing manufacturing defects in a hearing instrument described herein. The digital hearing aid system 1012 includes several external components 1014, 1016, 1018, 1020, 1022, 1024, 1026, 1028, and a single integrated circuit (IC) 1012A. It should be understood, however, that the functions of the single integrated circuit (IC) 1012A could also be implemented using a plurality of ICs or some other circuit configuration. The external components include a pair of microphones 1024, 1026, a tele-coil 1028, a volume control potentiometer 1024, a memory-select toggle switch 1016, battery terminals 1018, 1022, and a speaker 1020.

Sound is received by the pair of microphones 1024, 1026, and converted into electrical signals that are coupled to the FMIC 1012C and RMIC 1012D inputs to the IC 1012A. FMIC refers to “front microphone,” and RMIC refers to “rear microphone.” The microphones 1024, 1026 are biased between a regulated voltage output from the RREG and FREG pins 1012B, and the ground nodes FGND 1012F, RGND 1012G. The regulated voltage output on FREG and RREG is generated internally to the IC 1012A by regulator 1030.

The tele-coil 1028 is a device used in a hearing aid that magnetically couples to a telephone handset and produces an input current that is proportional to the telephone signal. This input current from the tele-coil 1028 is coupled into the rear microphone A/D converter 1032B on the IC 1012A when the switch 1076 is connected to the “T” input pin 1012E, indicating that the user of the hearing aid is talking on a telephone. The tele-coil 1028 is used to prevent acoustic feedback into the system when talking on the telephone.

The volume control potentiometer 1014 is coupled to the volume control input 1012N of the IC. This variable resistor is used to set the volume sensitivity of the digital hearing aid.

The memory-select toggle switch 1016 is coupled between the positive voltage supply VB 1018 to the IC 1012A and the memory-select input pin 1012L. This switch 1016 is used to toggle the digital hearing aid system 1012 between a series of setup configurations. For example, the device may have been previously programmed for a variety of environmental settings, such as quiet listening, listening to music, a noisy setting, etc. For each of these settings, the system parameters of the IC 1012A may have been optimally configured for the particular user. By repeatedly pressing the toggle switch 1016, the user may then toggle through the various configurations stored in the read-only memory 1044 of the IC 1012A.

The battery terminals 1012K, 1012H of the IC 1012A may, for example, be coupled to a single 1.3 volt zinc-air battery. This battery provides the primary power source for the digital hearing aid system.

The last external component is the speaker 1020. This element is coupled to the differential outputs at pins 1012J, 10121 of the IC 1012A, and converts the processed digital input signals from the two microphones 1024, 1026 into an audible signal for the user of the digital hearing aid system 1012.

There are many circuit blocks within the IC 1012A. Primary sound processing within the system is carried out by the sound processor 1038. A pair of A/D converters 1032A, 1032B are coupled between the front and rear microphones 1024, 1026, and the sound processor 1038, and convert the analog input signals into the digital domain for digital processing by the sound processor 1038. A single D/A converter 1048 converts the processed digital signals back into the analog domain for output by the speaker 1020. Other system elements include a regulator 1030, a volume control A/D 1040, an interface/system controller 1042, an EEPROM memory 1044, a power-on reset circuit 1046, and a oscillator/system clock 1036.

The sound processor 1038 may include a directional processor and headroom expander 1050, a pre-filter 1052, a wide-band twin detector 1054, a band-split filter 1056, a plurality of narrow-band channel processing and twin detectors 1058A-1058D, a summer 1060, a post filter 1062, a notch filter 1064, a volume control circuit 1066, an automatic gain control output circuit 1068, a peak clipping circuit 1070, a squelch circuit 1072, and a tone generator 1074.

Operationally, the sound processor 1038 processes digital sound as follows. Sound signals input to the front and rear microphones 1024, 1026 are coupled to the front and rear A/D converters 1032A, 1032B, which may, for example, be Sigma-Delta modulators followed by decimation filters that convert the analog sound inputs from the two microphones into a digital equivalent. Note that when a user of the digital hearing aid system is talking on the telephone, the rear A/D converter 1032B is coupled to the tele-coil input “T” 1012E via switch 1076. Both of the front and rear A/D converters 1032A, 1032B are clocked with the output clock signal from the oscillator/system clock 1036 (discussed in more detail below). This same output clock signal is also coupled to the sound processor 1038 and the D/A converter 1048.

The front and rear digital sound signals from the two A/D converters 1032A, 1032B are coupled to the directional processor and headroom expander 1050 of the sound processor 1038. The rear A/D converter 1032B is coupled to the processor 1050 through switch 1075. In a first position, the switch 1075 couples the digital output of the rear A/D converter 1032B to the processor 1050, and in a second position, the switch 1075 couples the digital output of the rear A/D converter 1032B to summation block 1071 for the purpose of compensating for occlusion.

Occlusion is the amplification of the users own voice within the ear canal. The rear microphone can be moved inside the ear canal to receive this unwanted signal created by the occlusion effect. The occlusion effect is usually reduced in these types of systems by putting a mechanical vent in the hearing aid. This vent, however, can cause an oscillation problem as the speaker signal feeds back to the microphone(s) through the vent aperture. Another problem associated with traditional venting is a reduced low frequency response (leading to reduced sound quality). Yet another limitation occurs when the direct coupling of ambient sounds results in poor directional performance, particularly in the low frequencies. The system shown in FIG. 12 solves these problems by canceling the unwanted signal received by the rear microphone 1026 by feeding back the rear signal from the A/D converter 1032B to summation circuit 1071. The summation circuit 1071 then subtracts the unwanted signal from the processed composite signal to thereby compensate for the occlusion effect.

The directional processor and headroom expander 1050 includes a combination of filtering and delay elements that, when applied to the two digital input signals, forms a single, directionally-sensitive response. This directionally-sensitive response is generated such that the gain of the directional processor 1050 will be a maximum value for sounds coming from the front microphone 1024 and will be a minimum value for sounds coming from the rear microphone 1026.

The headroom expander portion of the processor 1050 significantly extends the dynamic range of the A/D conversion, which is very important for high fidelity audio signal processing. It does this by dynamically adjusting the A/D converters 1032A/1032B operating points. The headroom expander 1050 adjusts the gain before and after the A/D conversion so that the total gain remains unchanged, but the intrinsic dynamic range of the A/D converter block 1032A/1032B is optimized to the level of the signal being processed.

The output from the directional processor and headroom expander 1050 is coupled to a pre-filter 1052, which is a general-purpose filter for pre-conditioning the sound signal prior to any further signal processing steps. This “pre-conditioning” can take many forms, and, in combination with corresponding “post-conditioning” in the post filter 1062, can be used to generate special effects that may be suited to only a particular class of users. For example, the pre-filter 1052 could be configured to mimic the transfer function of the user's middle ear, effectively putting the sound signal into the “cochlear domain.” Signal processing algorithms to correct a hearing impairment based on, for example, inner hair cell loss and outer hair cell loss, could be applied by the sound processor 1038. Subsequently, the post-filter 1062 could be configured with the inverse response of the pre-filter 1052 in order to convert the sound signal back into the “acoustic domain” from the “cochlear domain.” Of course, other pre-conditioning/post-conditioning configurations and corresponding signal processing algorithms could be utilized.

The pre-conditioned digital sound signal is then coupled to the band-split filter 1056, which may include a bank of filters with variable corner frequencies and pass-band gains. These filters are used to split the single input signal into four distinct frequency bands. The four output signals from the band-split filter 1056 may be in-phase so that when they are summed together in block 1060, after channel processing, nulls or peaks in the composite signal (from the summer) are minimized.

Channel processing of the four distinct frequency bands from the band-split filter 1056 is accomplished by a plurality of channel processing/twin detector blocks 1058A-1058D. Although four blocks are shown in FIG. 12, it should be clear that more than four (or less than four) frequency bands could be generated in the band-split filter 1056, and thus more or less than four channel processing/twin detector blocks 1058 may be utilized with the system.

Each of the channel processing/twin detectors 1058A-1058D provide an automatic gain control (“AGC”) function that provides compression and gain on the particular frequency band (channel) being processed. Compression of the channel signals permits quieter sounds to be amplified at a higher gain than louder sounds, for which the gain is compressed. In this manner, the user of the system can hear the full range of sounds since the circuits 1058A-1058D compress the full range of normal hearing into the reduced dynamic range of the individual user as a function of the individual user's hearing loss within the particular frequency band of the channel.

The channel processing blocks 1058A-1058D can be configured to employ a twin detector average detection scheme while compressing the input signals. This twin detection scheme includes both slow and fast attack/release tracking modules that allow for fast response to transients (in the fast tracking module), while preventing annoying pumping of the input signal (in the slow tracking module) that only a fast time constant would produce. The outputs of the fast and slow tracking modules are compared, and the compression slope is then adjusted accordingly. The compression ratio, channel gain, lower and upper thresholds (return to linear point), and the fast and slow time constants (of the fast and slow tracking modules) can be independently programmed and saved in memory 1044 for each of the plurality of channel processing blocks 1058A-1058D.

FIG. 12 also shows a communication bus 1059, which may include one or more connections, for coupling the plurality of channel processing blocks 1058A-1058D. This inter-channel communication bus 1059 can be used to communicate information between the plurality of channel processing blocks 1058A-1058D such that each channel (frequency band) can take into account the “energy” level (or some other measure) from the other channel processing blocks. Each channel processing block 1058A-1058D may take into account the “energy” level from the higher frequency channels. In addition, the “energy” level from the wide-band detector 1054 may be used by each of the relatively narrow-band channel processing blocks 1058A-1058D when processing their individual input signals.

After channel processing is complete, the four channel signals are summed by summer 1060 to form a composite signal. This composite signal is then coupled to the post-filter 1062, which may apply a post-processing filter function as discussed above. Following post-processing, the composite signal is then applied to a notch-filter 1064, that attenuates a narrow band of frequencies that is adjustable in the frequency range where hearing aids tend to oscillate. This notch filter 1064 is used to reduce feedback and prevent unwanted “whistling” of the device. The notch filter 1064 may include a dynamic transfer function that changes the depth of the notch based upon the magnitude of the input signal.

Following the notch filter 1064, the composite signal is then coupled to a volume control circuit 1066. The volume control circuit 1066 receives a digital value from the volume control A/D 1040, which indicates the desired volume level set by the user via potentiometer 1014, and uses this stored digital value to set the gain of an included amplifier circuit.

From the volume control circuit, the composite signal is then coupled to the AGC-output block 1068. The AGC-output circuit 1068 is a high compression ratio, low distortion limiter that is used to prevent pathological signals from causing large scale distorted output signals from the speaker 1020 that could be painful and annoying to the user of the device. The composite signal is coupled from the AGC-output circuit 1068 to a squelch circuit 1072, that performs an expansion on low-level signals below an adjustable threshold. The squelch circuit 1072 uses an output signal from the wide-band detector 1054 for this purpose. The expansion of the low-level signals attenuates noise from the microphones and other circuits when the input S/N ratio is small, thus producing a lower noise signal during quiet situations. Also shown coupled to the squelch circuit 1072 is a tone generator block 1074, which is included for calibration and testing of the system.

The output of the squelch circuit 1072 is coupled to one input of summer 1071. The other input to the summer 1071 is from the output of the rear A/D converter 1032B, when the switch 1075 is in the second position. These two signals are summed in, summer 1071, and passed along to the interpolator and peak clipping circuit 1070. This circuit 1070 also operates on pathological signals, but it operates almost instantaneously to large peak signals and is high distortion limiting. The interpolator shifts the signal up in frequency as part of the D/A process and then the signal is clipped so that the distortion products do not alias back into the baseband frequency range.

The output of the interpolator and peak clipping circuit 1070 is coupled from the sound processor 1038 to the D/A H-Bridge 1048. This circuit 1048 converts the digital representation of the input sound signals to a pulse density modulated representation with complimentary outputs. These outputs are coupled off-chip through outputs 1012J, 1012I to the speaker 1020, which low-pass filters the outputs and produces an acoustic analog of the output signals. The D/A H-Bridge 1048 includes an interpolator, a digital Delta-Sigma modulator, and an H-Bridge output stage. The D/A H-Bridge 1048 is also coupled to and receives the clock signal from the oscillator/system clock 1036.

The interface/system controller 1042 is coupled between a serial data interface pin 1012M on the IC 1012, and the sound processor 1038. This interface is used to communicate with an external controller for the purpose of setting the parameters of the system. These parameters can be stored on chip in the EEPROM 4044. If a “black-out” or “brown-out” condition occurs, then the power-on reset circuit 1046 can be used to signal the interface/system controller 1042 to configure the system into a known state. Such a condition can occur, for example, if the battery fails.

This written description uses examples to disclose the invention, including the best mode, and also to enable a person skilled in the art to make and use the invention. The patentable scope of the invention may include other examples that occur to those skilled in the art.

1. A system for diagnosing manufacturing defects in a digital hearing instrument, comprising:
a hearing instrument integrated circuit;
a hearing instrument component that is electrically connected to the hearing instrument integrated circuit; and
a diagnostic program stored in a memory location on the hearing instrument integrated circuit, the diagnostic program when executed by the hearing instrument integrated circuit being operable to test an operation of the hearing instrument component and indicate a failed operation of the hearing instrument component using a test indicator.

2. The system of claim 1, wherein the diagnostic program is firmware that is loaded to the hearing instrument integrated circuit prior to assembling the digital hearing instrument.

3. The system of claim 1, wherein the hearing instrument component is a microphone circuitry.

4. The system of claim 3, wherein the operation of the microphone circuitry is tested by monitoring an energy level of an output signal generated by the microphone circuitry, the diagnostic program indicating a failed operation of the microphone circuitry if the energy level of the output signal falls below a threshold level.

5. The system of claim 3, wherein the test indicator is a tone generator operable to generate an audio output signal, and wherein a failed operation of the microphone circuitry causes the test indicator to generate a first tone.

6. The system of claim 5, wherein a successful operation of the microphone circuitry causes the test indicator to generate a second pre-selected tone.

7. The system of claim 6, further comprising:
a receiver circuitry that is electrically connected to the hearing instrument integrated circuit;
wherein an operation of the receiver circuitry is tested by monitoring the system for the first or second pre-selected tone.

8. The system of claim 3, wherein the test indicator is a light source, and wherein a failed operation of the microphone circuitry causes the light source to turn on.

9. The system of claim 1, wherein the hearing instrument component is a receiver circuitry.

10. The system of claim 9, wherein the operation of the receiver circuitry is tested by generating a pre-determined audio output signal and monitoring for a concurrent drop in a battery voltage.

11. The system of claim 1, wherein the hearing instrument component is an input device.

12. The system of claim 11, wherein the input device is a trimmer.

13. The system of claim 12, wherein the operation of the trimmer is tested by generating an output with the test indicator and causing the frequency of the output to vary dependent upon which direction the trimmer is adjusted.

14. The system of claim 11, wherein the input device is a push-button switch.

15. The system of claim 14, wherein the operation of the push-button switch is tested by generating an output with the test indicator when the push-button switch is depressed.

16. The system of claim 1, further comprising a storage device, wherein the diagnostic program is further operable to store a test result in the storage device.

17. A method for diagnosing manufacturing defects in a digital hearing instrument, comprising:
loading a diagnostic program to a hearing instrument integrated circuit;
after the hearing instrument has been assembled, executing the diagnostic program;
the diagnostic program causing the hearing instrument integrated circuit to test an operation of a hearing instrument component that is electrically connected to the hearing instrument integrated circuit within the digital hearing instrument during assembly and further causing the hearing instrument integrated circuit to indicate a failed operation of the hearing instrument component using a test indicator; and
if a failed operation of the hearing instrument component is indicated by the test indicator, then verifying the electrical connection between the hearing instrument component and the hearing instrument integrated circuit.

18. The method of claim 17, wherein the diagnostic program monitors an energy level of an output signal generated by a microphone circuitry and causes the test indicator to generate a first output indicating a failed operation if the energy level of the output signal falls below a threshold level.

19. The method of claim 18, wherein the diagnostic program causes the test indicator to generate a second output indicating a successful operation if the energy level of the output signal does not fall below the threshold level.

20. The method of claim 19, wherein the first and second outputs are audible tones.

21. The method of claim 20, further comprising:
testing an operation of a hearing instrument receiver circuitry by listening for the first or the second outputs.

22. The method of claim 17, wherein the hearing instrument component is an input device.

23. The method of claim 22, wherein the input device is a trimmer, and wherein the operation of the trimmer is tested by generating an output with the test indicator and causing the frequency of the output to vary dependent upon which direction the trimmer is adjusted.

24. The method of claim 22, wherein the input device is a push-button switch, and wherein the operation of the push-button switch is tested by generating an output with the test indicator when the push-button switch is depressed.

25. The system of claim 17, wherein the hearing instrument component is a receiver circuitry.

26. The system of claim 25, wherein the operation of the receiver circuitry is tested by generating a pre-determined audio output signal and monitoring for a concurrent drop in a battery voltage.

27. The system of claim 17, wherein the diagnostic program stories a test result in a storage device.

28. A diagnostic program stored in a memory location on a hearing instrument integrated circuit, the diagnostic program when executed being operable to perform method steps comprising:
automatically causing the hearing instrument integrated circuit to test an operation of a hearing instrument component; and
automatically causing the hearing instrument integrated circuit to indicate a failed operation of the hearing instrument component using a test indicator.

29. The diagnostic program of claim 28, wherein the diagnostic program monitors an energy level of an output signal generated by a microphone circuitry and causes the test indicator to generate a first output indicating a failed operation if the energy level of the output signal falls below a threshold level.

30. The diagnostic program of claim 28, wherein the hearing instrument component is a trimmer, and wherein the diagnostic program tests the operation of the trimmer by generating an output with the test indicator and causing the frequency of the output to vary dependent upon which direction the trimmer is adjusted.

31. The method of claim 28, wherein the input device is a push-button switch, and wherein the diagnostic program tests the operation of the push-button switch by generating an output with the test indicator when the push-button switch is depressed.

32. The system of claim 28, wherein the hearing instrument component is a receiver circuitry, and wherein the diagnostic program test the operation of the receiver circuitry by generating a pre-determined audio output signal and monitoring for a concurrent drop in a battery voltage.

33. The system of claim 28, wherein the diagnostic program is further operable to store a test result in a storage device.
